(19) United States
(12) Patent Application Publication
(10) Pub. No.: US 2003/0068550 A1
(43) Pub. Date: Apr. 10, 2003

(54) Electrode material and applications therefor

(76) Inventors: Katsuhiko Naoi, Tokyo (JP); Kotaro Kobayashi, Okayama-shi (JP); Yukihiro Fujita, Okayama-shi (JP)

Correspondence Address: W. L. Gore & Associates, Inc., 551 Paper Mill Road, P.O. Box 9206, Newark, DE, 19714-9206, US

(21) Appl. No.: 10/112,603

(22) Filed: Mar. 27, 2002

(30) Foreign Application Priority Data
Oct. 1, 2001 (JP) 01-305474

(51) Int. Cl. H01M 4/60; H01M 4/62; H01M 4/66

(52) U.S. Cl. 429/213; 429/232; 429/245

(57) ABSTRACT

An electrode material designed for use in an electrode for a storage element and composed of a carbon material/electroconductive polymer composite in which the surface of a carbon material with a large specific surface, preferably a carbon material with a specific surface of 30 m²/g or greater, and more specifically a material in the form of particles, tubes, or fibers, is coated with an electroconductive polymer that initiates redox reactions during the adsorption and desorption of protons and/or during the doping and undoping of ions other than protons; an electrode for a storage element featuring this material; and a electrode with a collector for a storage element obtained by a process in which a dispersion of the material is dried after being applied to one or both sides of the collector.

### FIELD OF THE INVENTION

The present invention relates to a storage element, particularly to an electrode material used for capacitors and cells, and to an electrode and a storage element featuring this material. More particularly, the present invention relates to an electrode material for a storage element in which an electroconductive polymer is used as the primary storage material, to an electrode, and to a storage element.

### BACKGROUND OF THE INVENTION

In conventional practice, capacitors are storage devices in which a group of electrodes composed of a pair of polarized electrodes separated by an ion-permeable porous plate are immersed in an electrolyte solution, and in which the electric double layer created by the application of voltage is utilized. Capacitors are storage devices similar to secondary cells, but because the storage mechanism of capacitors is based on the capacity of the electric double layer, they can charge and discharge faster and perform longer than secondary cells, whose operation involves electrochemical reactions. On the other hand, the presence of the electric double layer results in an energy density that is no more than 1/10 that of a secondary cell. The capacity of an electric double layer is proportional to the surface area of the electrodes, so electroconductive materials with substantial specific surfaces are used in actual practice. Activated carbon (obtained by activating a carbon material) fashioned into fibers or powders is commonly used. Although some types of activated carbon can reach a specific surface of about 3000 m²/g, the pore size distribution thereof is very wide and the pores that can actually adsorb or desorb electrolyte ions are limited in number, making it impossible so far to obtain an electrostatic capacity that would be proportional to specific surface. By contrast, it has become possible in recent years to make adjustments by alkali activation such that the required pores alone are opened in a comparatively narrow range, allowing higher-capacity capacitors to be obtained. Even with this type of activated carbon, however, the energy density of the capacitor commonly reaches its limit at about 10 Wh/kg, and thus falls far short of the energy density delivered by a secondary cell.

There are two ways of enhancing energy density, one of which is to raise the operating voltage and the other to increase the capacitive density. An organic solvent system having a higher decomposition voltage can be used for raising the operating voltage. The voltage of an organic solvent system is about 3 V, or about 4 V at the most, which is about 3 to 4 times higher than that of an aqueous system, but the presence of large electrolyte ions reduces the electrostatic capacity and makes meaningful increases in energy density impossible to achieve. In addition, a dramatic increase in capacitive density is virtually impossible to achieve with the currently available activated carbon, making it necessary to rely on pseudo-capacity (electrochemical capacity).

Development work has been done in recent years concerning storage devices in which pseudo-capacity is provided by electroconductive polymers or metal oxides. The polyacene-based material disclosed in JP (Kokai) 58-136649 is a typical example of an electroconductive polymer. However, polyacene-based materials have an inadmissibly low reaction velocity and high internal resistance because they involve doping and undoping of ions. To improve the capacity and internal resistance of electroconductive polymers, it has been proposed to combine the polymers with carbon (JP (Kokai) 7-91449) or fine metal particles (JP (Kokai) 11-283886). However, merely adding carbon or metal to an electroconductive polymer fails to improve the unacceptably low electrical conductivity of the electroconductive polymer and makes it difficult for the material to deliver its best performance.

In view of the above-described issues, the present invention is aimed at providing an electrode material that allows a high-capacity, low-resistance durable capacitor, secondary cell, or other storage element to be obtained by improving the unacceptably low electrical conductivity of electroconductive polymers, at providing an electrode featuring this material, and at providing a storage element featuring this electrode.

### SUMMARY OF THE INVENTION

The present invention provides an electrode material designed for use in an electrode for a storage element and composed of a carbon material/electroconductive polymer composite in which the surface of a carbon material with a large specific surface, preferably a carbon material with a specific surface of 30 m²/g or greater, and more specifically a material in the form of particles, tubes, or fibers, is coated with an electroconductive polymer that initiates redox reactions during the adsorption and desorption of protons and/or during the doping and undoping of ions other than protons; in an electrode for a storage element featuring this material; and in a electrode with a collector for a storage element obtained by a process in which a dispersion of the material is dried after being applied to one or both sides of the collector.

The carbon material is activated carbon or carbon black, particularly acetylene black or furnace black; and the electroconductive polymer is a 1,5-diaminoanthraquinone polymer or oligomer, or a polymer or oligomer primarily containing 1,5-diaminoanthraquinone, in which case the present invention resides in an electrode material designed for use in an electrode for a storage element and composed of a carbon material/electroconductive polymer composite in which the surface of a carbon material with a large specific surface, preferably a carbon material with a specific surface of 30 m²/g or greater, and specifically a material in the form of particles, tubes, or fibers, is coated with an electroconductive polymer that initiates redox reactions during the adsorption and desorption of protons and/or during the doping and undoping of ions other than protons and that is a 1,5-diaminoanthraquinone polymer or oligomer, or a polymer or oligomer primarily containing 1,5-diaminoanthraquinone; in an electrode for a storage element featuring this material; and in a electrode with a collector for a storage element obtained by a process in which a dispersion of the material is dried after being applied to one or both sides of the collector.

The inventive electrode for a storage element may optionally contain a dopant involved in doping and undoping, activated carbon powder or graphite powder, and/or a fluororesin as a binding agent, in which case the specific surface of the activated carbon powder may have a mean grain size of 30 μm or less and a specific surface of 2500 m²/g or less, and the graphite powder may have a mean grain size of 10 μm or less and a specific surface of 15 m²/g or less. The fluororesin is polytetrafluoroethylene. An electrode in which polytetrafluoroethylene is used as a binder is characterized by being in sheet form, in which case an electrode with a collector for a storage element may be obtained by integration with the collector or by drying a dispersion of the material after applying the dispersion to one or both sides of the collector.

Another feature of the present invention is that the electrode with a collector for a storage element may be in the form of a gilded resin foil, an electroconductive elastomer sheet, an electroconductive plastic sheet, a carbon sheet, or aluminum, nickel, titanium, or stainless steel fashioned into rolled foil, etched foil, expanded metal foil, punching metal foil, gilded foil, or platinum-coated foil.

Another main point of the present invention is a storage element in which the aforementioned electrode, either alone or with a collector, is used for the positive electrode and/or negative electrode.

### DETAILED DESCRIPTION OF THE INVENTION

Carbon Material with Large Specific Surface

According to the present invention, a carbon material is used for the core of the electrode material.

Irrespective of the shape, the specific surface of the carbon material should preferably be 30 m²/g or greater.

An excessively small specific surface reduces the coating amount when the electroconductive polymer is applied in a thin layer, making it impossible to obtain high capacity.

The carbon material should preferably be in the form of particles, tubes, or fibers. The carbon material coated with the electroconductive polymer should preferably contain a minimal amount of impurities to make it easier to apply the electroconductive polymer. In the case of a particulate carbon material, therefore, it is considered appropriate to use a product whose fine particles undergo secondary aggregation and form a structure, such as acetylene black, furnace black, or activated carbon particles with large pore diameters. Specifically, the carbon material may be carbon black in which particles measuring 0.1 nm or less are connected into chains, or activated carbon whose mean grain size ranges from 5 μm to about 30 μm. In the case of tubes or fibers, the diameter and length of the formations should preferably be about 0.1-10 μm and about 5-30 μm, respectively. Comparatively small formations are preferred because of their large specific surface.

Electroconductive Polymer that Initiates Redox Reactions During Adsorption/Desorption of Protons and/or During Doping/Undoping of Ions other than Protons

An electroconductive polymer in which redox reactions are conducted using protons as carriers can have low internal resistance and can be charged and discharged relatively rapidly because of the high proton dispersion rate.

The electroconductive polymer should preferably be a 1,5-diaminoanthraquinone polymer or oligomer, or a polymer or oligomer primarily containing 1,5-diaminoanthraquinone. Numerous proton-exchanging electroconductive polymers are known, but 1,5-diaminoanthraquinone can be expected to have comparatively high capacity, increased output, and long service life because it has proton exchange capabilities, a redox mechanism, and a laminar structure. Other electroconductive polymers with such proton exchange capabilities are also expected to be able to deliver the same effects. These materials include polyaniline, polypyrrole, polypyridine, polypyrimidine, benzoquinone, and other compounds having quinoid structures.

Carbon Material/Electroconductive Polymer Composite

The electrode material of the present invention is obtained by coating the surface of the carbon material with an electroconductive polymer that initiates redox reactions during the adsorption and desorption of protons and/or during the doping and undoping of ions other than protons.

Numerous methods may be used to form a composite comprising a carbon material and an electroconductive polymer. Chemical polymerization conducted in the presence of a carbon material is preferred for use in the present invention. An example of chemical polymerization is a method in which a monomer and a carbon material are finely dispersed and reacted in a propylene carbonate/methanol solution. A water/methanol solution, DMSO (dimethyl sulfoxide), or the like may be used as a synthesis bath in this case.

The same effect can be obtained by synthesis through electrolytic polymerization.

When the carbon material is carbon black, the resulting composite is configured such that a structure obtained by the aggregation of primary carbon black particles is coated with an electroconductive polymer. When the carbon material is activated carbon, the resulting composite is configured such that the surface of the particulate activated carbon is coated with an electroconductive polymer, which also penetrates into the pores of the activated carbon. When the carbon material is in tube form, the electroconductive polymer covers not only the outside walls of the tubes but also the inside walls thereof. When the carbon material is in fiber form, the electroconductive polymer covers the entire outside surface of the fibers.

The thickness of the coating layer formed by the electroconductive polymer should preferably be 100 nm or less. A thickness of 1-10 nm is particularly preferred if output characteristics are taken into account.

As used in connection with the present invention, the term “storage element” refers to a capacitor or secondary cell. As used herein, the term “capacitor” refers to a storage element that operates based on an electric double layer rather than an electrochemical reaction and that is capable of charging and discharging at an extremely high rate. The term “secondary cell” refers to an element that operates based on reversible electrochemical reactions and that is capable of repeated charging and discharging.

The electrode obtained using the above-described carbon material/electroconductive polymer composite material is characterized by containing a dopant involved in doping and undoping. Since this system consumes protons, a dopant should preferably be present in the electrode as a supporting electrolyte. Examples of suitable dopants include ClO₄⁻, Cl⁻, BF₄⁻, and acceptor dopants.

The electrode obtained using this carbon material/electroconductive polymer composite material is also characterized by containing activated carbon powder or graphite powder. These have the effect of providing the bulk of the electrode with better electrical conductivity.

According to the present invention, the electrode material used to produce an electrode for a storage element may be a carbon material/electroconductive polymer composite obtained by a process in which the surface of a carbon material with a large specific surface is coated with an electroconductive polymer that initiates redox reactions during the adsorption and desorption of protons and/or during the doping and undoping of ions other than protons.

An electroconductive polymer in which redox reactions are conducted using protons as carriers can have low internal resistance and can be charged and discharged relatively rapidly because of the high proton dispersion rate. Thinly applying such a material to the surface of a carbon material having a large specific surface and excellent electrical conductivity will therefore retain the desired coating amount without adversely affecting the electrical conductivity of the electroconductive polymer as such. Using such a carbon material/electroconductive polymer composite as an electrode material will make it possible to provide a high-capacity, low-resistance electrode for a storage element and a high-capacity, low-resistance storage element.

The carbon material should preferably be in the form of particles, tubes, or fibers. The carbon material coated with the electroconductive polymer should preferably contain a minimal amount of impurities to make it easier to apply the electroconductive polymer. In the case of a particulate carbon material, therefore, it is considered appropriate to use a product whose fine particles form a structure, such as acetylene black, furnace black (commonly called carbon black), or activated carbon particles with large pore diameters. Specifically, the carbon material may be carbon black in which particles measuring 0.1 nm or less are connected into chains, or activated carbon whose mean grain size ranges from 5 to about 30 μm. In the case of tubes or fibers, the diameter and length of the formations should preferably be about 0.1-10 μm and about 5-30 μm, respectively. Comparatively small formations are preferred because of their large specific surface. Carbon nanotubes can be cited as an example of carbon material in tube form, and vapor-grown carbon fibers can be cited as an example of carbon material in fiber form.

The electroconductive polymer should preferably be a 1,5-diaminoanthraquinone polymer or oligomer, or a polymer or oligomer primarily containing 1,5-diaminoanthraquinone. Numerous proton-exchanging electroconductive polymers are known, but 1,5-diaminoanthraquinone can be expected to have comparatively high capacity, increased output, and long service life because it has proton exchange capabilities, a redox mechanism, and a laminar structure. Other electroconductive polymers with such proton exchange capabilities are also expected to be able to deliver the same effects. These materials include polyaniline, polypyrrole, polypyridine, polypyrimidine, benzoquinone, and other compounds having quinoid structures.

The electrode obtained using a carbon material/electroconductive polymer composite as the principal electrode material may also contain a dopant involved in doping and undoping as another electrode material. Since this system consumes protons, the dopant should preferably be present in the electrode as a supporting electrolyte. Examples of suitable dopants include ClO₄⁻, Cl⁻, BF₄⁻, and acceptor dopants. Tetraethylammonium perchlorate can be cited as the preferred dopant.

The electrode obtained using a carbon material/electroconductive polymer composite as the principal electrode material may also contain activated carbon powder or graphite powder as another electrode material. These have the effect of providing the bulk of the electrode with better electrical conductivity.

In this case, the activated carbon powder should preferably have a mean grain size of about 5-30 μm and a specific surface of about 1000-2500 m²/g, and the graphite powder should preferably have a mean grain size of about 0.5-10 μm, and a specific surface of about 1-15 m²/g. These should preferably be added to the electrode material in an amount of about 5-20 wt % because adding too little of either material is ineffective whereas adding too much reduces the capacitive density of the overall volume. These contribute to improved electrical conductivity and electrode machinability.

The present invention entails producing a capacitor electrode by making use of such an electrode material. Specifically, an electrode with a collector can be obtained by forming an electrode layer on the collector by a method in which a dispersion medium such as 1-methyl-2-pyrrolidone or an alcohol (ethanol, methanol, or the like) is added to the electrode material to obtain a dispersion or a paste; the dispersion or paste is then applied to one or both sides of the collector; and the coated collector is dried to remove the dispersion medium.

The desired electrode material may also be fashioned into a sheet to obtain a sheet electrode. In this case, an electrode with a collector can be obtained by laminating and integrating the sheet electrode with the collector.

A binding agent may be used in all these cases in order to bind the desired electrode material. Examples of suitable binding agents include vinylidene fluoride, polytetrafluoroethylene, and other fluororesins. In particular, polytetrafluoroethylene is characterized by chemical and thermal stability and the absence of film formation, and thus has only a minimally adverse effect on the performance of the carbon material/electroconductive polymer composite and other electrode material components when made into an electrode. The binding agent should be used in an amount of about 5-30%, and preferably about 5-15%. (The amount is expressed as the weight ratio of the agent in the electrode material.)

The electrode material is sheeted by a method in which polytetrafluoroethylene powder is admixed as a binding agent into a carbon material/electroconductive polymer composite to which the above-described dopant or conduction aid has been appropriately added, a lubricant is then added to the resulting mixture, and the resulting paste is extruded as a sheet and calendered with calendering rolls into a sheet product. The lubricant is subsequently removed by heating and drying. Examples of suitable lubricants include paraffin oil and alcohols such as ethanol and methanol. The lubricant is used in an amount of about 100-300 wt % in relation to the electrode material.

The electrode of the present invention is integrated into a collector to obtain an electrode with a collector in the above-described manner. The collector should preferably be composed of aluminum, nickel, titanium, stainless steel, tantalum, or another metal. These metals may be used in the form of rolled foil, etched foil, expanded metal foil, or punching metal foil. The foil may be provided with a baked coating or plated with gold, platinum, or the like. Gilded resin foil may also be used. It is also possible to use an electroconductive elastomer sheet (such as a carbon-added butyl rubber sheet), a carbon-added plastic sheet, a carbon sheet, or the like.

In the case of a sheeted electrode obtained using the electrode material, the integration of the electrode and the collector can be achieved by a method involving compression bonding, a method involving the use of an electroconductive adhesive, or the like.

According to the present invention, a button-type capacitor can be obtained by a method in which a pair of electrodes with collectors are prepared, a separator is interposed between them, and the assembly is sealed together with an electrolyte by means of a metal casing, a sealing plate, and a gasket for insulating the two components from each other.

A roll-type capacitor can be obtained by a method in which an electrode with a collector in the form of a strip is superposed on a separator and rolled into a capacitor unit, the capacitor unit is placed inside a metal casing, and the assembly is impregnated with an electrolyte and sealed.

A stacked capacitor can be obtained by a method in which an electrode with a collector is fashioned into rectangles and alternately superposed on separators to form an electrode/separator stack; a positive electrode lead and a negative electrode lead are crimped onto the positive and negative ends of the electrodes, respectively, to form a capacitor unit; the capacitor unit is placed in a metal casing; and the unit is impregnated with an electrolyte and sealed.

Although the above description was given with reference to a capacitor, the same structure can be used for a secondary cell.

The separator may be a hydrophilized porous sheet made of polytetrafluoroethylene, polyethylene, polypropylene, or the like; a porous sheet made of sisal hemp; or another conventional product.

The electrolyte may be an aqueous system having a supporting electrolyte and primarily containing H₂SO₄ or HCl. Tetraethylammonium tetrafluoroborate/propylene carbonate or another organic product may also be used.

### WORKING EXAMPLES

Following is a detailed description of examples related to capacitors whose electrodes were obtained using the carbon material/electroconductive polymer composite of the present invention as electrode materials. The present invention is not limited by these working examples, however.

### Working Example 1

The following method was used to fabricate a carbon material/electroconductive polymer composite in a case in which acetylene black was used as the bonded carbon material, and 1,5-diaminoanthraquinone was used as the electroconductive polymer that initiated redox reactions during the adsorption and desorption of protons and/or during the doping and undoping of ions other than protons.

Fabrication of Composite Material by Synthesis

1,5-Diaminoanthraquinone (monomer; amount: 50 g), carbon black (acetylene black; specific surface: 35 m²/g; amount: 50 g), methanol (2 L), and a 1N HCl aqueous solution (2.5 L) were added to a reaction container. A flask with the reaction mixture was immersed in an ultrasonic washer and exposed to ultrasonic waves for 10 minutes at room temperature. Ammonium peroxodisulfate (15 g) was then dissolved in a 1N HCL aqueous solution (0.5 L), and the resulting solution was slowly added in drops to the reaction mixture. The product was then exposed to ultrasonic waves for 3 hours at room temperature, filtered, and dried, yielding a composite material.

Infrared analysis (FT-IR) and transmission electron microscopy (TEM) were used to identify the composite material thus obtained. FT-IR measurements confirmed that the electroconductive polymer on the surface of carbon black had formed a 1,5-diaminoanthraquinone polymer layer. TEM was used to observe the formation of a composite from carbon black and the electroconductive polymer, and it was found that the electroconductive polymer had formed a coating on the surface of an aggregate consisting of continuously bonded primary particles of carbon black. The coating layer had a thickness of about 1 nm.

The composite material was used to obtain a sheet electrode with a thickness of 100 μm in the manner described below. Polytetrafluoroethylene powder was used as a binder, graphite with a mean grain size of 5 μm (specific surface: 15 m²/g) was used as a conduction aid, and tetraethylammonium perchlorate was used as a dopant.

The components were used in a weight ratio of 70:15:15:150 (composite material/PTFE powder/conduction aid/dopant).

(1) A mixed material was prepared by admixing 200 mass parts of ethanol (lubricant) per 100 mass parts of the composite material, binder, conduction aid, and dopant.

(2) A sheet with a thickness of 100 μm was fabricated by rolling and extruding the composite material after placing it between a pair of rolls heated to 50° C.

(3) The sheet was then dried in a 150° C. oven to remove the lubricant.

A gilded PET film collector was crimped onto the sheet electrode, the product was laminated to a microporous PTFE membrane separator with a thickness of 25 μm, a 4M H₂SO₄ aqueous solution was introduced in a prescribed amount, and the assembly was sealed, yielding a capacitor.

### Working Example 2

A composite and a capacitor were fabricated in the same manner as in Working Example 1 except that the coated composite material was carbon black (Vulcan XC-72R from Cabot) with a specific surface of 250 m²/g.

### Working Example 3

A composite and a capacitor were fabricated in the same manner as in Working Example 1 except that the coated composite material was carbon black (Ketjen Black from Ketjen Black International) with a specific surface of 800 m²/g.

### Working Example 4

A composite and a capacitor were fabricated in the same manner as in Working Example 1 except that the coated composite material was a vapor-grown carbon fiber (VGCF from Showa Denko) with a specific surface of 15 m²/g.

### Working Example 5

A composite and a capacitor were fabricated in the same manner as in Working Example 1 except that the coated composite material was activated carbon powder with a mean grain size of 15 μm and a specific surface of 1500 m²/g.

### Working Example 6

A composite and a capacitor were fabricated in the same manner as in Working Example 1 except that the conduction aid added to the electrode was activated carbon powder with a mean grain size of 15 μm and a specific surface of 2800 m²/g.

### Working Example 7

A composite and a capacitor were fabricated in the same manner as in Working Example 1 except that the conduction aid added to the electrode was activated carbon powder with a mean grain size of 30 μm and a specific surface of 1800 m²/g.

### Working Example 8

A composite and a capacitor were fabricated in the same manner as in Working Example 1 except that the conduction aid added to the electrode was activated carbon powder with a mean grain size of 50 μm and a specific surface of 1000 m²/g.

### Working Example 9

A composite and a capacitor were fabricated in the same manner as in Working Example 1 except that the conduction aid added to the electrode was graphite with a mean grain size of 10 μm and a specific surface of 15 m²/g.

### Working Example 10

A composite and a capacitor were fabricated in the same manner as in Working Example 1 except that the conduction aid added to the electrode was graphite with a mean grain size of 15 μm and a specific surface of 8 m²/g.

### Working Example 11

A composite and a capacitor were fabricated in the same manner as in Working Example 1 except that the conduction aid added to the electrode was graphite with a mean grain size of 30 μm and a specific surface of 5 m²/g.

Comparative examples will now be described.

### Comparative Example 11

A polarized electrode in which an activated carbon/polyacene-based material composite was formed on a carbon substrate (collector) was obtained in accordance with Working Example 5 of JP (Kokoku) 7-91449 by employing as the starting materials the phenolic activated carbon powder and phenolic resin powder described in No. 14 of Working Example 5.

A capacitor was fabricated in the same manner as in Working Example 1 except that this polarized electrode was used.

### Comparative Example 2

A polarized electrode in which fine metal particles were continuously formed throughout polythiophene and which was integrated with aluminum foil as a collector substrate was obtained in accordance with a working example of JP (Kokai) 11-283886 (see FIG. 8 of the publication). This polarized electrode was used to fabricate a capacitor in the same manner as in Working Example 1.

### Comparative Example 3

A composite material other than carbon black was used in accordance with Working Example 1 in an attempt to synthesize a composite. Rather than being a composite, the resulting product turned out to be composed of 1,5-diaminoanthraquinone alone. A capacitor was fabricated in the same manner as in Working Example 1 except that this product was used.

The capacitors of the working and comparative examples described above were charged and discharged between 0 and 1000 mV, and their capacity was calculated by integrating the resulting discharge curves. To grade the capacity, capacitive density was calculated by dividing capacity values by the weight of two electrodes. An equivalent series resistance was measured at 1 kHz and 10 mA.

The results are shown in Table 1.

It can be seen that Working Examples 1 to 11 of the present invention deliver a much better performance than do Comparative Examples 1 to 3, which lack a carbon material composite such as the one provided for by the present invention. Capacitive density increases with an increase in the specific surface of the coated carbon material. This is attributed to an increase in the coating amount due to a larger surface area of coating. Resistance and service life are also markedly increased in comparison with the absence of compositing. It is believed that sufficiently high capacity and low resistance can be obtained at a specific surface of 30 m²/g or greater. When the specific surface is less than 30 m²/g, high capacity and low resistance commensurate with electrical conductivity can still be obtained in the case of fibrous graphite in the form of vapor-grown carbon fibers. High capacity and low resistance can also be obtained by employing other types of activated carbon. Although the above description was given with reference to powders and fibers, the same effect can be obtained for tubes, furnace black, graphite, and activated carbon.

Capacity is increased and resistance reduced by the introduction of graphite during electrode formation, and performance improves with a reduction in the grain size of the graphite used in the process. The same effect can be obtained using activated carbon or any other non-graphite material.

TABLE 1

| | | | | Capacitive | Equivalent | Capacity retention |
|---|---|---|---|---|---|---|
| | | Carbon material | Conduction | density during | series | rate after |
| Item | Polymer | or metal | aid | 5th cycle (F/g) | resistance (Ω) | 1000 cycles (%) |
| Working | DAAQ | AB | Graphite (5) | 350 | 1 | 80 |
| Example 1 | | | | | | |
| Working | DAAQ | XC-72R | Graphite (5) | 450 | 0.9 | 90 |
| Example 2 | | | | | | |
| Working | DAAQ | KB | Graphite (5) | 500 | 0.8 | 85 |
| Example 3 | | | | | | |
| Working | DAAQ | VGCF | Graphite (5) | 450 | 0.9 | 85 |
| Example 4 | | | | | | |
| Working | DAAQ | AC | Graphite (5) | 500 | 1.1 | 78 |
| Example 5 | | | | | | |
| Working | DAAQ | AB | AC (15) | 350 | 1.1 | 78 |
| Example 6 | | | | | | |
| Working | DAAQ | AB | AC (30) | 300 | 1.2 | 80 |
| Example 7 | | | | | | |
| Working | DAAQ | AB | AC (50) | 250 | 1.3 | 78 |
| Example 8 | | | | | | |
| Working | DAAQ | AB | Graphite (10) | 350 | 1 | 80 |
| Example 9 | | | | | | |
| Working | DAAQ | AB | Graphite (15) | 320 | 1.1 | 75 |
| Example 10 | | | | | | |
| Working | DAAQ | AB | Graphite (30) | 300 | 1.2 | 73 |
| Example 11 | | | | | | |
| Comparative | PAS | — | — | 200 | 1.8 | 50 |
| Example 1 | | | | | | |
| Comparative | PP | Fine metal | — | 180 | 1.6 | 35 |
| Example 2 | | powder | | | | |
| Comparative | DAAQ | — | — | 100 | 2.5 | 5 |
| Example 3 | | | | | | |

1. An electrode material, designed for use in the production of an electrode for a storage element comprising a composite of a carbon material with a large specific surface and an electroconductive polymer that coats said specific surface of said carbon material, and wherein said electroconductive polymer initiates redox reactions during the adsorption and desorption of protons and/or during the doping and undoping of ions other than protons.

2. An electrode material as defined in claim 1, wherein the specific surface of the carbon material is 30 m²/g or less.

3. An electrode material as defined in claim 1, wherein the carbon material is in the form of tubes or fibers.

4. An electrode material as defined in claim 1, wherein the carbon material is carbon black or activated carbon.

5. An electrode material as defined in claim 4, wherein the carbon black is acetylene black or furnace black.

6. An electrode material as defined in claim 1, wherein the electroconductive polymer is a 1,5-diaminoanthraquinone polymer or oligomer, or a polymer or oligomer primarily containing 1,5-diaminoanthraquinone.

7. An electrode for a storage element, obtained using an electrode material as defined in any of claims 1.

8. An electrode for a storage element as defined in claim 7, containing a dopant involved in doping and undoping.

9. An electrode for a storage element as defined in claim 7, containing activated carbon powder or graphite powder.

10. An electrode for a storage element as defined in claim 9, wherein the activated carbon powder has a mean grain size of 30 μm or less and a specific surface of 2500 m²/g or less.

11. An electrode for a storage element as defined in claim 9, wherein the graphite powder has a mean grain size of 10 μm or less and a specific surface of 15 m²/g or less.

12. An electrode for a storage element as defined in claim 7, containing a fluororesin as a binding agent.

13. An electrode for a storage element as defined in claim 12, wherein the fluororesin is polytetrafluoroethylene.

14. An electrode for a storage element as defined in claim 13, characterized in that the electrode in which polytetrafluoroethylene is used as a binder is in sheet form.

15. An electrode with a collector for a storage element, wherein the sheet electrode of claim 14 is integrated with the collector.

16. An electrode with a collector for a storage element, obtained by a process in which a dispersion of an electrode material as defined in claim 1 is dried after being applied to one or both sides of the collector.

17. An electrode with a collector for a storage element as defined in claim 15, wherein the collector is a gilded resin foil, an electroconductive elastomer sheet, an electroconductive plastic sheet, a carbon sheet, or aluminum, nickel, titanium, or stainless steel fashioned into rolled foil, etched foil, expanded metal foil, punching metal foil, gilded foil, or platinum-coated foil.

18. A storage element, wherein an electrode or electrode with a collector as defined in claim 7 is used for the positive electrode and/or negative electrode.
